(19) United States
(12) Patent Application Publication
(10) Pub. No.: US 2025/0362173 A1
(43) Pub. Date: Nov. 27, 2025

(54) LIGHT ALTERING DEVICES FOR LIGHT SENSORS

(71) Applicant: Hewlett-Packard Development Company, L.P., Spring, TX (US)

(72) Inventors: Chia-Wen Chuang, Taipei City (TW); Chia-Hung Chu, Taipei City (TW); Yi-Hsien Lin, Taipei City (TW); Hui Leng Lim, Spring, TX (US); Hung-Ming Chen, Taipei City (TW); Alan Man Pan TAM, Spring, TX (US); Chien-Feng Chu, Taipei City (TW)

(73) Assignee: Hewlett-Packard Development Company, L.P., Spring, TX (US)

(21) Appl. No.: 18/872,582

(22) PCT Filed: Jul. 20, 2022
(86) PCT No.: PCT/US2022/037672

§ 371 Date: Dec. 6, 2024

(51) Int. Cl. G01J 1/04; G01J 1/42; G06F 1/16; H04N 23/71; H04N 23/88

(52) U.S. Cl. CPC G01J 1/0425; G01J 1/4204; G06F 1/1686; H04N 23/71; H04N 23/88

(57) ABSTRACT

The present disclosure describes a device that includes an enclosure, a cover glass coupled to the enclosure to cover a side portion of the enclosure, a light sensor directed to receive light through the cover glass, and a light altering device positioned between the light sensor and the cover glass to collect light from a position blocked by the enclosure.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can utilize imaging instructions to alter image properties. In some examples, the computing devices can utilize different features of the surrounding area to alter the image properties.

### BRIEF DESCRIPTION OF THE DRAWINGS

FIG. 1 illustrates an example of a system that includes light altering devices for a light sensor.

FIG. 2 illustrates an example of a system that includes light altering devices for a light sensor.

FIG. 3 illustrates an example of a light altering device for a light sensor.

FIG. 4 illustrates an example of a system that includes light altering devices for a light sensor.

FIG. 5 illustrates an example of a memory resource storing instructions for executing image alterations based on ambient light of an area.

### DETAILED DESCRIPTION

A user may utilize a computing device for various purposes, such as for business and/or recreational use. As used herein, the term “computing device” refers to an electronic system having a processor (e.g., processor resource, hardware processor, etc.) and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

Computing devices can be utilized with a plurality of peripheral devices and/or embedded devices. For example, the computing devices can include imaging devices to capture images within an area of the computing device. In other examples, the computing devices can include display devices to display images and/or display a graphical user interface (GUI). In some examples, the display device can be coupled to an enclosure of the computing device. For example, the display device can utilize an enclosure to protect computing components within the enclosure. In these examples, the display device can be coupled to the enclosure and the display device can be protected by a cover glass.

As used herein, a cover glass can be a transparent material (e.g., plastic, glass, etc.) that can be utilized to protect components while allowing the components to be viewable. In this way, the cover glass can protect the display device and other components within the enclosure while allowing light to pass through the cover glass. In some examples, the enclosure may be a non-transparent or opaque material that can prevent light from entering the enclosure. For example, the enclosure can be a metal or opaque plastic material that may not allow light to penetrate the material.

In some examples, the computing device can utilize a light sensor (e.g., ambient light sensor, etc.) to determine light properties of an area. In these examples, an image can be captured by an imaging device (e.g., camera, video camera, etc.) and the captured image can be altered based on the light properties of the area. In this way, the image is altered to improve overall image quality of the image. In some examples, auto-white balance (AWB) can be utilized to alter the image properties based on the light properties captured by the light sensor.

In some examples, the light sensor may have limitations under particular conditions. For example, the light sensor may not be able to correctly identify the light properties of an ambient light source and/or correctly identify the light properties to be utilized when altering the image properties. In this example, the light sensor may be directed toward an object or subject of the image to be captured. For example, some light sensors are directed in the same direction as the imaging device to capture ambient light from the same direction as the imaging device. However, the light sensor may not be capable of correctly capturing the light properties of the area when the object or subject is positioned in front of a single color background. That is, the ambient light sensor is not able to correctly identify the light properties associated with the light source within the error, which can lead to errors when altering the image properties based on the light properties. For example, an AWB process can balance a yellow color to grey instead of balancing the yellow color.

The present disclosure describes systems and devices that alter a direction of light toward an input of a light sensor such that the light sensor receives light from a light source. As described further herein, the light source may be positioned over the computing device such that the light is directed to the enclosure which may make it difficult for the light sensor to determine the properties of the light from the light source. The present disclosure describes a device that includes an enclosure, a cover glass coupled to the enclosure to cover a side portion of the enclosure, a light sensor directed to receive light through the cover glass, and a light altering device positioned between the light sensor and the cover glass to collect light from a position blocked by the enclosure.

In this way, the light altering device directs light to the light sensor even when the light is blocked by a portion of the enclosure. As used herein, a light altering device alters a direction of light from a first direction to a second direction. In some examples, light altering devices can reflect, refract, bend, or otherwise change the direction of the light. For example, the light from an overhead light may be directed to the enclosure or be on an opposite side of the device than the cover glass. In this example, the light altering device can capture light from the overhead light and direct the light to the input of the light sensor. In this way, the properties of the light can be correctly identified and utilized by the computing device. In specific examples, light altering devices include fiber optic devices, lens devices, mirrored devices, and/or other devices that alter the direction of the light or capture light from a first direction and provide the light in a second direction.

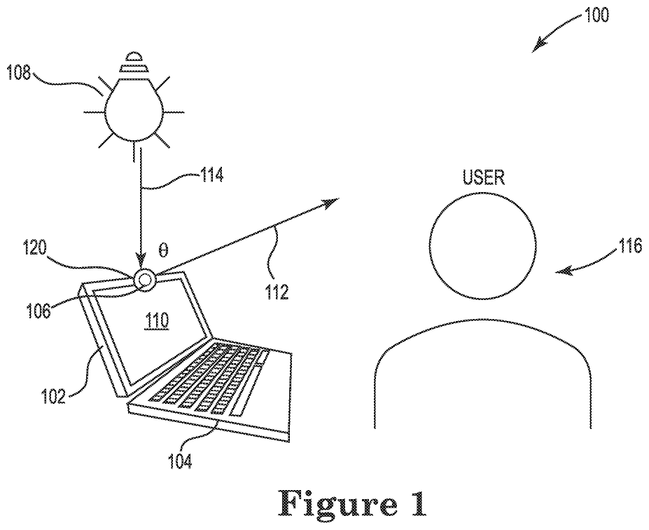

FIG. 1 illustrates an example of a system 100 that includes light altering devices 120 for a light sensor. The system 100 can include a computing device 102. The system 100 illustrates a computing device 102 as a laptop with a display device and a keyboard 104, however other types of computing devices can be utilized in a similar way. For example, the computing device 102 can be a mobile computing device such as a tablet or smartphone. In other examples, the display device can be a peripheral device that is coupled to the computing device 102. For example, the computing device 102 can be a desktop computing device that includes a display device that is separate from the desktop tower.

In some examples, the system 100 includes a light sensor 106. The light sensor 106 can be a sensor that detects a quantity of light and/or light properties of light captured at an input. For example, the light sensor 106 can be an ambient light sensor or ambient color sensor. In some examples, the ambient color sensor can generate a value for a plurality of different colors that are detected at the input of the sensor. In these examples, the values of the plurality of colors can be provided to the computing device 102. In some examples, the computing device 102 can utilize the color values for the plurality of colors. For example, the computing device 102 can utilize the values associated with the plurality of colors to perform an auto-white balance (AWB) function. As used herein, AWB refers to altering image properties to balance a color temperature of the image to bring an overall color temperature of the image to neutral. The AWB function can alter the image incorrectly or distort the image when the plurality of color values are incorrect or altered.

In some examples, the system 100 can include an area with an object 116. The object 116 can be a human user or other type of subject that is being captured by an imaging device of the computing device 102. As used herein, an imaging device can include a still image camera, video camera, infrared camera, or other type of device that can images of the object 116 and a surrounding area. In these examples, the imaging device may be coupled to an interior portion of the computing device 102 between an interior back portion of an enclosure and a cover glass 110. In some examples, the imaging device can be positioned in a direction of arrow 112. As described herein, the light sensor 106 may be directed to the same location and/or coupled to the interior back portion of the enclosure in the same direction as the imaging device. For example, the light sensor 106 may be directed in the direction of arrow 112.

In some examples, the system 100 includes a light source 108 that can direct light within the area. In some examples, the light source 108 is emanating direct light in the direction of arrow 114 toward the computing device 102. In this way, the direct light from the light source 108 can be directed toward the enclosure of the computing device 102 and may not be able to enter directly through the cover glass 110. That is, the light sensor 106 may be detecting light that is directed from the object 116 and/or a background (e.g., wall, objects, etc.) behind or around the object 116. As described herein, the light from the light source 108 can be altered or more difficult to accurately detect when the light is interacting with the object 116 and/or background of the object 116. Thus, the color values and/or magnitude of the light from the light source 108 may be identified by the light sensor 106 incorrectly, which can lead to errors when utilizing the color values and/or magnitude captured by the light sensor 106.

In some examples, the angle between the arrow 122 representing the direction of the light sensor 106 and/or imaging device and the arrow 114 representing a direct path from the light source 108 to the computing device 102 can be represented by theta (θ). In this way, theta can represent an angle that a light altering device 120 can direct the light from the light source 108 to an input of the light sensor 106. As described further herein, a light altering device 120 can be utilized to capture and/or direct light from the direction of arrow 114 to be received at an input of the light sensor 106. In this way, more direct light from the light source 108 can be utilized to determine the color values and/or magnitude of the light generated by the light source 108.

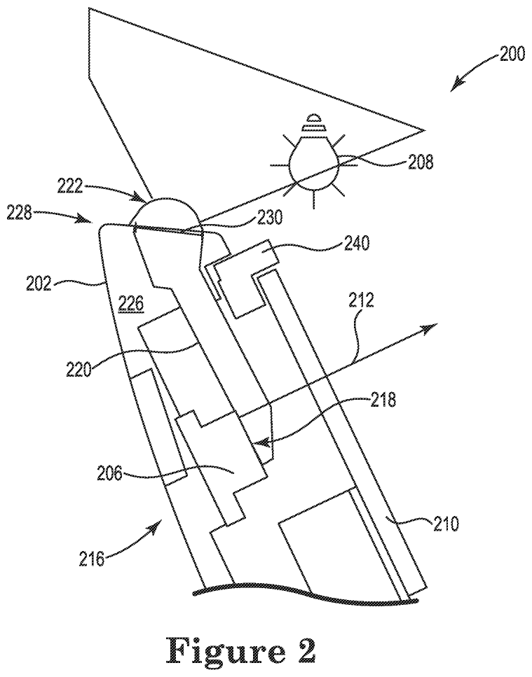

FIG. 2 illustrates an example of a system 200 that includes light altering devices 220 for a light sensor 206. In some examples, the system 200 can illustrate a portion of the system 100 as referenced in FIG. 1. For example, the system 200 can represent a portion of the computing device 102 as referenced in FIG. 1. The system 200 can include an enclosure 226 that includes a side 216 (e.g., back side, etc.) and an edge 228 (e.g., top edge, right edge, left edge, bottom edge, etc.). The enclosure 226 can be utilized to protect components of the computing device (e.g., processor, memory resource, light sensor 206, etc.) on the side 216 and a plurality of edges include the edge 228. In some examples, the computing device includes a cover glass 210 that can be coupled to the enclosure 226 at a plurality of edges including the edge 228 utilizing a coupling mechanism 240.

In this way, the cover glass 210 can protect the computing device on a first side and the enclosure 226 can create a sealed area to protect components between the enclosure 226 and the cover glass 210. In some examples, the enclosure 226 can be made of a material that is different than the cover glass 210. For example, the enclosure 226 can be made of an opaque material (e.g., metal, opaque plastic, etc.) while the cover glass 210 is made of a transparent or substantially transparent material (e.g., glass, transparent plastic, etc.). In some examples, a light sensor 206 can be coupled to an interior portion of the enclosure 226. That is, the light sensor 206 can be coupled to an interior portion of the side 216 between an interior surface of the enclosure 226 and an interior surface of the cover glass 210.

The light sensor 206 can include a sensor to receive light from a light source 208 and a circuit assembly (e.g., printed circuit board, communication cable, etc.) to process the light received from the light source 208. The light sensor 206 can receive light from the light source through an input 218. In some examples, light that does not reach the input 218 may not be detected by the light sensor 206. As described herein, the input 218 of the light sensor 206 may be directed toward a subject of an image to be captured by an imaging device. For example, the input 218 can be directed in the direction of arrow 212 to receive light through the cover glass 210. However, the light from the light source 208 may not be able to reach the input 218 of the light sensor 206 when the light source 208 is positioned between the enclosure 226 and the input 218 of the light sensor 206. For example, the light from the light source 208 have to be reflected by a surface before entering through the cover glass 210 before hitting the input 218 of the light sensor 206.

In some examples, the system 200 can include a light altering device 220 that is positioned between the input 218 of the light sensor 206 and the cover glass 210. In some examples, the light altering device 220 is a device that is able to collect light from a first end and provide the light at a second end. For example, the light altering device 220 can be a lens, light pipe, fiber optic device, among other devices that are able to direct light from a first location to a second location. The light altering device 220 can be coupled to an aperture 230 of the enclosure 226 to direct light from the edge 228 of the enclosure 226 to the input 218 of the light sensor. That is, the light altering device 220 is a fiber optic device that is positioned within the aperture 230 to direct light directed at the edge 228 of a plurality of edges of the enclosure 226 to the input 218 of the light sensor 206. In this way, the light altering device 220 can direct light from the aperture 230 to the input 218 of the light sensor 206 such that more direct light from the light source 208 can be captured at the input 218 of the light sensor 206.

In some examples, the light altering device 220 can include a lens 222 to direct light from the light source 208 more directly into the light altering device 220. For example, the lens 222 can focus light from the light source 208 into a fiber optic device when the light altering device 220 is a fiber optic device. The lens 222 can allow a higher magnitude of light to be captured at the input 218 of the light sensor 206 to allow the light sensor 206 to more accurately determine a color value for a plurality of colors of the light. In some examples, the lens 222 is a Fresnel lens coupled to the aperture 230 of the edge 228 of the enclosure 226 to focus light directed to the edge 228 toward the light altering device 220. As used herein, a Fresnel lens is a lens that includes a set of concentric annular sections. In this way, the amount of material utilized can be reduced. For example, the set of concentric annular sections effectively divides the continuous surface of a standard lens into a set of surfaces of the same curvature, with stepwise discontinuities between them.

In this way, the light sensor 206 can utilize more direct light from the light source 208 through the light altering device 220 compared to receiving light through the cover glass 210. In some examples, the light received through the cover glass 210 can also pass through the light altering device 220 and be received at the input 218 of the light sensor 206.

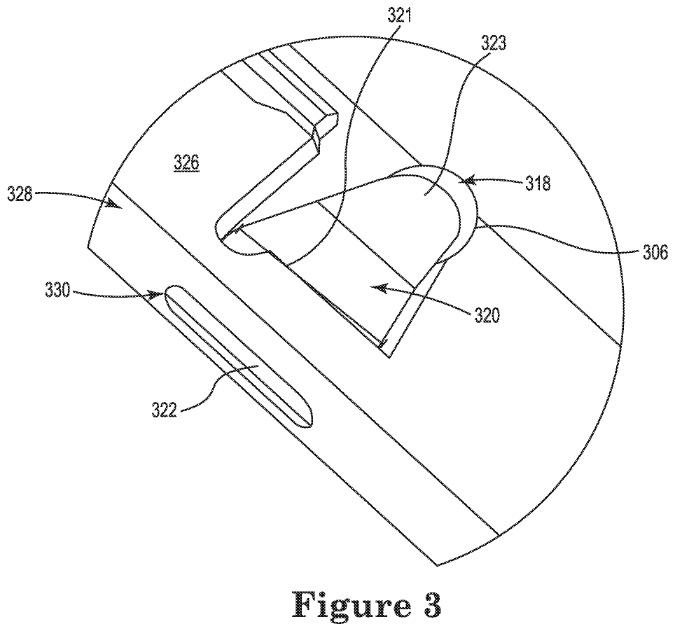

FIG. 3 illustrates an example of a light altering device 320 for a light sensor 306. FIG. 3 illustrates a close-up view of a cut away version of an enclosure 326 of a computing device to illustrate a view of the light altering device 320 positioned between the aperture 330 of the enclosure 326 to an input 318 of a light sensor 306. As described herein, the light altering device 320 can comprise a fiber optic or light pipe material that is able to receive light at the aperture 330 of the edge 328 of the enclosure 326 and transfer the captured light to the input 318 of the light sensor 306.

In some examples, the aperture 330 can be covered by a lens 322 or cover material to protect the light altering device 320. In other examples, the lens 322 includes an optical device to direct light into the light altering device 320 or magnify the light into the light altering device 320. In this way, the light can be captured by the lens 322 at the edge 328 of the enclosure 326 and directed into the light altering device 320 to be provided to the input 318 of the light sensor 306. In some examples, without the aperture 330 and/or light altering device 320, the light from a light source would have to reflect from a surface that is parallel to the input 318 of the light sensor 306 and pass through a cover glass as described herein.

In some examples, the shape of the light altering device 320 can promote a greater quantity of light to be provided to the input 318 of the light sensor 306. For example, the light altering device 320 can have a first distance 321 (e.g., first width, etc.) proximate to the aperture 330 and a second distance 323 (e.g., second width, etc.) proximate to the input 318 of the light sensor 306. In this way, the light captured at the aperture 330 by the light altering device 320 can be focused from a relatively wider portion a relatively thinner portion near the input 318 of the light sensor 306. That is, the light altering device 320 can have a taper in the width as illustrated by the first distance 321 and the second distance 323.

In a similar way, the light altering device 320 can have a first thickness (e.g., first vertical distance as illustrated in FIG. 3) that is perpendicular to the first distance 321 proximate to the aperture 330 and a second thickness (e.g., second vertical distance as illustrated in FIG. 3, etc.) that is perpendicular to the second distance 323 proximate to the input 318 of the light sensor 306. That is the light altering device 320 can have a taper in the thickness from the aperture 330 or the lens 322 to the input 318 of the light sensor 306. In these examples, the width and the thickness can both be tapered from the aperture 330 or lens 322 to focus light captured from a relatively broader and thicker area to a relatively shorter and thinner area. In this way, a great quantity of direct light can be provided to the input 318 of the light sensor 306 to provide better color values from a light that is directed to the edge 328 of the enclosure 326.

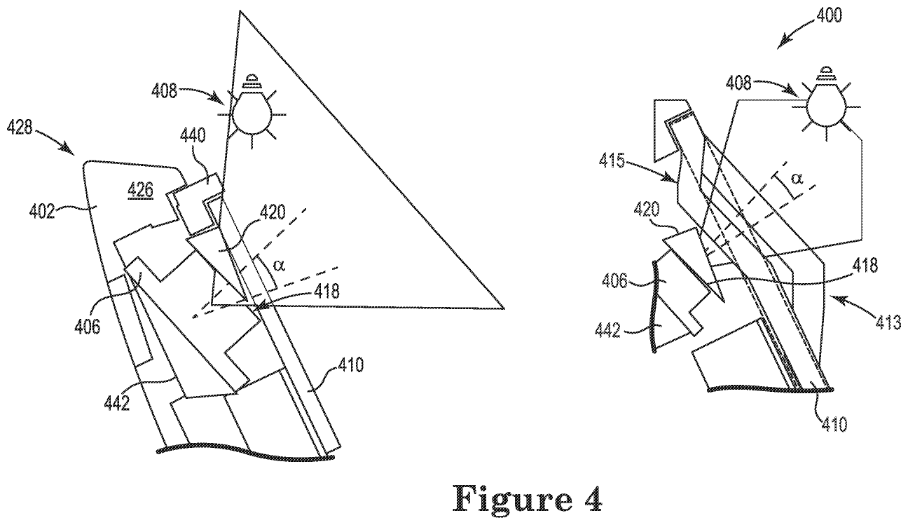

FIG. 4 illustrates an example of a system 400 that includes light altering devices 420 for a light sensor 406. In some examples, the system 400 includes the same or similar elements as FIG. 2. For example, the system 400 includes an enclosure 426 with a cover glass 410 coupled to the enclosure 426 by a mounting mechanism 440, In these examples, the enclosure 426 may comprise an opaque or substantially opaque material that may prevent or substantially prevent light from a light source 408 to reach the interior of the enclosure 426. In these examples, the cover glass 410 may include a transparent or substantially transparent material that allows light from the light source 408 to penetrate through.

As described herein, a light sensor 406 can include an input 418 to receive light through the cover glass 410. Some previous examples mount the light sensor 406 in a similar direction as an imaging device. However, as described herein, the direction of the imaging device can be based on a location of a potential subject of captured images (e.g., human user, etc.). This direction may be detrimental to allowing light from the light source 408 to enter the input 418 of the light sensor through the cover glass 410 since the enclosure 426 may not let the light from the light source 408 to enter the interior of the enclosure.

In some examples, the light sensor 406 is coupled to a mounting bracket 442 with an inclined plane. For example, the mounting bracket 442 can have a taper from a top portion near a first edge of the light sensor 406 to a bottom portion near a second edge of the light sensor 406. In this way, the input 418 of the light sensor is altered by an angle of alpha (α). The angle of alpha represents a change in an angle of the direction of the input 418 between having a bracket 442 with an inclined plane and removing the bracket 442 to mount the light sensor 406 on an interior surface of the enclosure 426.

Altering the direction of the input 418 to be toward an edge 428 of the enclosure 426 can ensure that a greater quantity of light is received directly from the light source 408. In some examples, the angle alpha can be approximately 5 degrees. In other examples, the angle alpha can be greater than 10 degrees but less than 15 degrees. In this way, the input 418 of the light sensor 406 is directed toward a potential light source 408 and/or directed away from a work surface. For example, it can be determined that the bracket 442 would direct the input 418 of the light sensor 406 above a direction of the imaging device. That is, the imaging device would be directed toward a subject of an image to be captured by the imaging device, which can indicate that a light source 408 for the subject would be above the subject, above the edge 428, and/or behind the edge 428.

In some examples, the system 400 includes a light altering device 420 that is positioned at an input 418 of the light sensor 406. As described herein, the light altering device 420 can be utilized to direct or focus light toward the input 418 of the light sensor 406. In these examples, the light altering device 420 can be an optical device that is positioned between the cover glass 410 and the input 418 of the light sensor 406. In this way, the angle alpha and the light altering device 420 can allow more direct light from the light source 408 to be received at the input 418 of the light sensor 406.

In some examples, the light altering device 420 can be embedded within the cover glass 410 to further direct light into the input 418 of the light sensor 406. For example, the cover glass 410 can have a convex 415 or concave 413 shape that is embedded within the cover glass 410 to direct more light toward the light altering device 420 and/or toward the input 418 of the light sensor 406. In some examples, the concave 413 or convex 415 shape of the cover glass 410 can alleviate reflection loss due to the light sensor 406 being in a tilted position. For example, the cover glass 410 can include a convex 415 or concave 413 portion in the line of sight of the input 418 of the light sensor 406 to prevent the total reflection loss due to the alpha angle of the light sensor 406. In this way, the light sensor 406 can capture relatively better ambient light data without loss caused by total reflection. In a similar way, the light altering device 420 may be positioned between the input 418 of the light sensor 406 and the cover glass 410 to prevent light data loss caused by total reflection.

In some examples, the concave 413 shape can be an indented portion of the cover glass 410 where the cover glass 410 is bent toward an interior portion of the enclosure 416 to direct light toward the input 418 of the light sensor 406. In this way, the concave 413 shape portion of the cover glass 410 can shaped as a concave lens from the cover glass 410. In a similar way, the convex 415 shape can be a portion that protrudes from the surface of the cover glass 410 to direct light toward the input 418 of the light sensor 406. In these examples, the convex 415 shape can be formed as a convex lens from the cover glass 410. In some examples, the convex 415 and/or concave 413 can be formed from the material of the cover glass 410 through a manufacturing process of the cover glass 410, such that a flat portion of the cover glass extends over a display portion of the system 400 and the convex 415 or concave 413 shape can be formed in line with the input 418 of the light sensor 406. In some examples, the manufacturing process can include utilizing a polymethyl methacrylate (PMMA) material for the cover glass 410. The PMMA can be a synthetic resin produced from the polymerization of methyl methacrylate. In this way, the convex 415 or concave 413 shaped can be formed utilizing shaping tools that can carve out the convex 415 or concave 413 out of the PMMA material.

In some examples, angle alpha is determined based on an angle between a display device and a keyboard device when the system 400 (e.g., computing device, etc.) is a laptop computing device. In this way, an angle between the keyboard and display that is utilized when the imaging device is capturing a human subject can be utilized to identify the angle alpha.

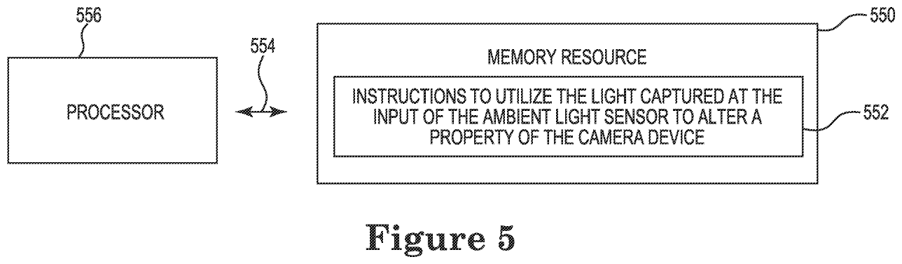

FIG. 5 illustrates an example of a memory resource 550 storing instructions for executing image alterations based on ambient light of an area. In some examples, the memory resource 550 can be a part of a computing device or controller that can be communicatively coupled to a computing system. For example, the memory resource 550 can be part of a laptop computing device or tablet computing device that utilizes an ambient light sensor.

In some examples, the memory resource 550 can be communicatively coupled to a processor 556 that can execute instructions 552 stored on the memory resource 550. For example, the memory resource 550 can be communicatively coupled to the processor 556 through a communication path 554. In some examples, a communication path 554 can include a wired or wireless connection that can allow communication between devices and/or components within a single device.

The memory resource 550 may be electronic, magnetic, optical, or other physical storage device that stores executable instructions. Thus, a non-transitory machine readable medium (MRM) (e.g., a memory resource 550) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 550) may be disposed within a controller and/or computing device. In this example, the executable instructions 552 can be “installed” on the device. Additionally, and/or alternatively, the non-transitory machine readable medium (e.g., a memory resource 550) can be a portable, external or remote storage medium, for example, which allows a computing system to download the instructions 552 from the portable/external/remote storage medium. In this situation, the executable instructions may be part of an “installation package”. As described herein, the non-transitory machine readable medium (e.g., a memory resource 550) can be encoded with executable instructions for determining a quantity of alignment operations to be performed and/or determining a quantity of time to perform alignment operations.

The instructions 552, when executed by the processor 556, can include instructions to utilize the light captured at the input of the ambient light sensor to alter a property of the camera device. As described herein, the ambient light can be captured by an ambient color sensor. The instructions 552 can utilize the color values identified by the ambient color sensor to alter properties of the camera device (e.g., imaging device, etc.). In some examples, the color values can be utilized to execute an auto-white balance (AWB) for a video feed based on the color values associated with the light received at the input of the ambient color sensor.

As described herein, the color values of the light received at the input of the ambient color sensor can be altered or skewed if the light is reflecting off of a particular surface (e.g., monotoned surface, single color surface, etc.). In this way, the color values that are identified by the ambient color sensor can positively or negatively affect an output image. For example, incorrect color values can degrade an image and result in poor color balancing. In a similar way, accurate color values that are identified can allow the processor 556 to increase a quality of the image through color balancing or other image altering processes.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A device, comprising:
an enclosure;
a cover glass coupled to the enclosure to cover a side portion of the enclosure;
a light sensor directed to receive light through the cover glass; and
a light altering device positioned between the light sensor and the cover glass to collect light from a position blocked by the enclosure.

2. The device of claim 1, wherein the light altering device is a fiber optic device.

3. The device of claim 2, wherein the fiber optic device extends from the light sensor through an aperture of the enclosure.

4. The device of claim 3, wherein the fiber optic device has a first width at the aperture of the enclosure and a second width that is smaller than the first width at an input of the light sensor.

5. The device of claim 1, wherein the enclosure prevents light from entering an interior portion of the enclosure and the cover glass allows light to enter the interior portion of the enclosure.

6. A computing device, comprising:
an enclosure that covers a first side and a plurality of edges;
a cover glass coupled to the enclosure at the plurality of edges to provide a second side;
a light sensor coupled to an interior surface of the enclosure between the first side and the second side to receive ambient light through an input; and
a light altering device coupled to the input of the light sensor to collect light directed to an edge of the plurality of edges.

7. The computing device of claim 6, wherein the edge of the plurality of edges includes an aperture to receive a portion of the light altering device.

8. The computing device of claim 7, wherein the light altering device is a fiber optic device that is positioned within the aperture to direct light directed at the edge of the plurality of edges to the input of the light sensor.

9. The computing device of claim 6, wherein the light altering device is a lens to direct light directed at the edge of the plurality of edges to the input of a light source.

10. The computing device of claim 6, wherein the edge of the plurality of edges is directed toward an overhead light source during operation.

11. A system, comprising:
a base device coupled to a display device by a hinge mechanism;
an enclosure of the display device;
a cover glass coupled to the enclosure;
a camera coupled to the enclosure;
a bracket coupled to an interior portion to provide an angled mounting position for an ambient light sensor;
the ambient light sensor coupled to the bracket such that an input is directed toward the cover glass at an angle of the bracket;
a light altering device coupled to an aperture of an edge of the enclosure and positioned over the input of the ambient light sensor to provide light collected at the edge of the enclosure to the input of the ambient light sensor; and
a processor to:
utilize the light captured at the input of the ambient light sensor to alter a property of the camera device.

12. The system of claim 11, wherein the property of the camera is a camera auto-white balance (AWB) of the camera.

13. The system of claim 11, comprising a Fresnel lens coupled to the aperture of the edge of the enclosure to focus light directed to the edge toward the light altering device.

14. The system of claim 11, wherein light altering device is a light pipe that tapers from the aperture of the edge of the enclosure to the input of the ambient light sensor.

15. The system of claim 14, wherein the light pipe tapers in a first direction and tapers in a second direction such that a width of the light pipe and a thickness of the light pipe decrease in size from the aperture to the input of the light sensor.
